(19) United States
(12) Patent Application Publication
(10) Pub. No.: US 2012/0164595 A1
(43) Pub. Date: Jun. 28, 2012

(54) ARTICULATOR

(76) Inventor: CHIH-CHIANG SU, Yonghe- City (TW)

(21) Appl. No.: 12/978,370

(22) Filed: Dec. 23, 2010

(51) Int. Cl. A61C 11/00

(52) U.S. Cl. 433/54

(57) ABSTRACT

A denture articulator is provided for coupling denture casts to allow for occlusal adjustment of the casts. The articulator includes a base, a cross bar, and a top. The casts are mounted to the top and base by cast holder seats or cast retainer seats for simulation of mastication and occlusal adjustment. The top allows a user to adjust the vertical location of the cast and also allows the user to adjust the elevation of the cast.

### (a) TECHNICAL FIELD OF THE INVENTION

The present invention generally relates to a dentistry articulator, and more particularly to an improved dentistry articulator capable of adjustment of height and angle of denture casts.

### (b) DESCRIPTION OF THE PRIOR ART

To make dentures for dental patients, a denture model or casts are a vital tool. An articulator carries the casts mounted thereon for performing occusal adjustment of the casts. Mounting the casts on the articulator allows a dentist to simulate mastication and occlusion occurring inside the mouth cavity of the dental patient, of which a record is made to allow a dental technician to manufacture dentures for the patient.

However, the conventional articulator is structured for simulating just the movements of maxillae and mandible, whereby the conventional articulator, when operated in adjusting occlusion of casts, can only be operated to open and close vertically for simulation of occlusion. The dentist has no way to precisely simulate the mastication and occlusion of the casts inside the mouth cavities of different patients.

Further, to use the conventional articulator, a dentist needs to apply plaster to the casts in order to mount the casts to the articulator for precise simulation of occlusion movement and overcome any problem of gaps existing between the articulator and the casts due to improper angular positions.

Although mounting the cast to the articulator in this way may overcome the problem of gap between the articulator and the casts, yet due to the fact that each user has a unique dentition configuration, different plaster forms must be provided according to the dentition structures of different patients. The plaster is then disposed of. This is generally against environmental protection and also increases the expense of making denture models.

### SUMMARY OF THE INVENTION

An objective of the present invention is to provide an improved articulator, which allows for adjustment of heights of both maxillary and mandibular casts and also allows for adjustment opening degree and elevation angle of the maxillary cast.

Another objective of the present invention is to provide an improved articulator, which is used in combination with cast holder seats or cast retainer seat to eliminate the problem of being environmentally non-conservative and increased cost of denture model manufacture.

To achieve the above objectives, the present invention provides an articulator, which comprises a base, a cross bar, and a top. The base comprises a mandibular cast receptacle for coupling a cast. The base comprises two upward-extending height adjustable rods. The cross bar is mounted on the two height adjustable rods. The cross bar forms an inner-threaded hole, and the inner-threaded hole threadingly receives and engages an adjustment bolt. The cross bar comprises two arms extending from opposite ends thereof. The top is rotatably mounted to the cross bar. The top comprises a maxillary cast receptacle, a lip, a pivot shaft, and at least one elevation adjusting element. The maxillary cast receptacle couples a cast. The lip is coupled to the two arms of the cross bar and comprises an extension that extends under the adjustment bolt in order to allow the adjustment bolt engages the extension. The pivot shaft extends through the lip and is coupled to the two arms of the cross bar so that the top is rotatable about the pivot shaft. The elevation adjusting element is coupled between the maxillary cast receptacle and the lip for fine adjustment of the elevation angle of the maxillary cast receptacle.

The present invention further comprises two cast retainer seats and two cast holder seats, whereby casts are mounted by the cast retainer seats or the cast holder seats to the articulator.

Through the technical solution adopted in the present invention, since the base of the articulator of the present invention comprises two height adjustable rods for adjusting the heights of the cross bar and the top and since a user may operate the adjustment bolt to adjust the elevation angle of the maxillary cast receptacle, and also operates the elevation adjusting elements to perform fine adjustment of the elevation angle of the maxillary cast receptacle, the present invention may realize adjustment of angular positions for precise simulation and adjustment of occlusal movement of casts inside oral cavity of a patient, to thereby achieve precise result of simulation and adjustment of the denture model and being applicable to casts of various sizes. As such, the present invention overcomes the conventional simulation operation carried out with a conventional articulator that can only perform vertical opening and closing.

Further, the present invention allows casts to be coupled to the cast retainer seats or the cast holder seats in such a way that the cast retainer seats or the cast holder seats may mount the casts to an articulator as a replacement of using plaster to mount casts to a conventional articulator that is environmentally non-conservative and increases the costs of manufacturing casts.

The foregoing objectives and summary provide only a brief introduction to the present invention. To fully appreciate these and other objects of the present invention as well as the invention itself; all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an articulator according to the present invention.

FIG. 2 is an exploded view of the articulator according to the present invention.

FIG. 3 is an exploded view of a top and a cross bar of the articulator of the present invention.

FIG. 4 is a schematic showing a cast and a cast holder seat according to a first embodiment, which are detached from each other.

FIG. 5 is a schematic view showing the cast and the cast holder seat of the first embodiment, which are assembled together.

FIG. 6 is a schematic view illustrating aligning of the casts.

FIG. 7 is another schematic view illustrating aligning of the casts.

FIG. 8 is a further schematic view illustrating aligning of the casts.

FIG. 9 is a schematic view illustrating a cast and a cast retainer seat according to a second embodiment.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

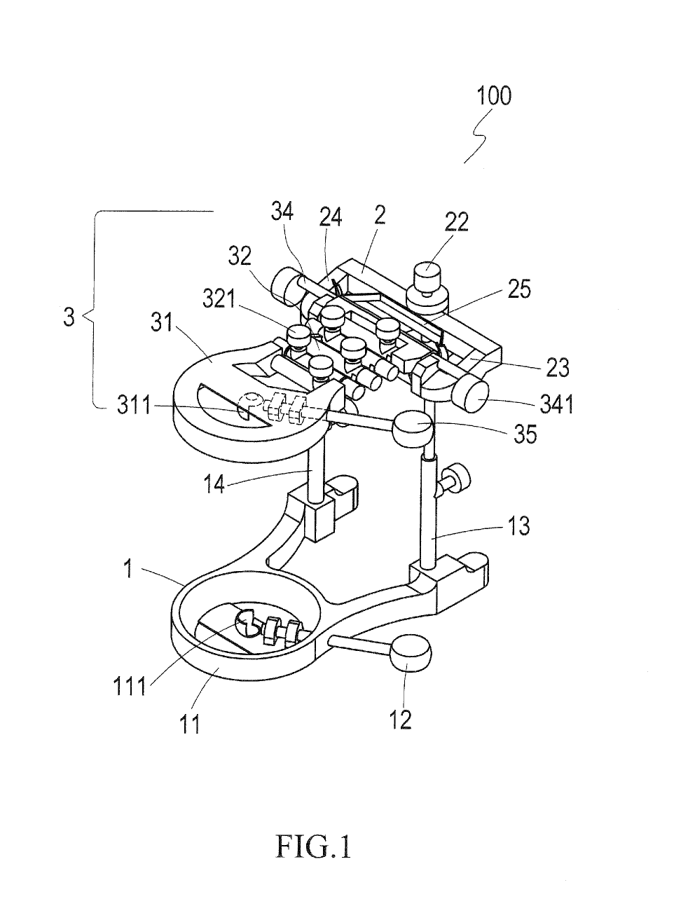

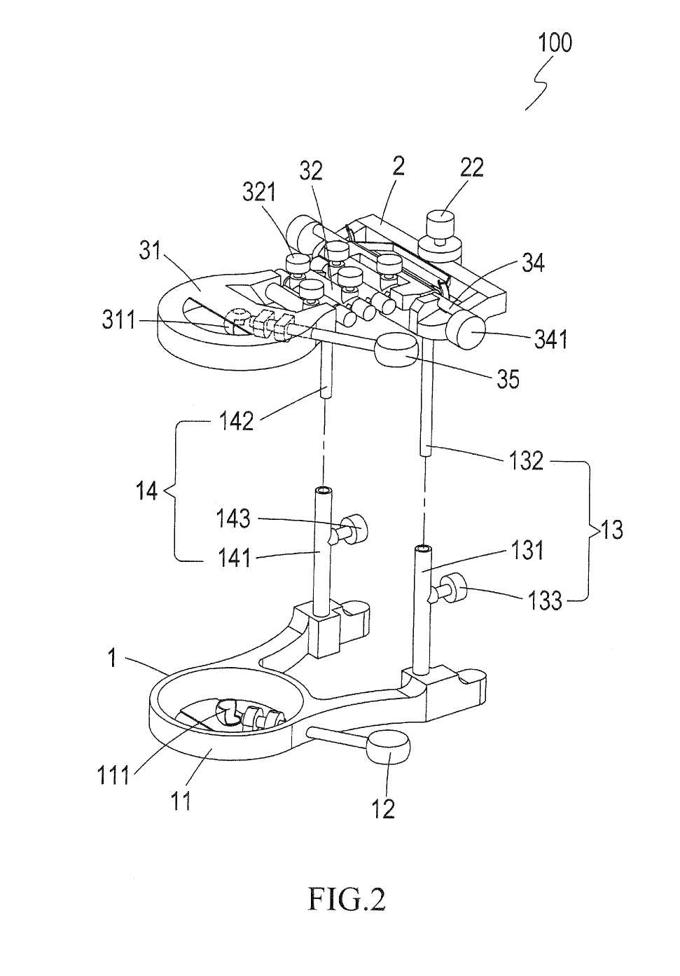

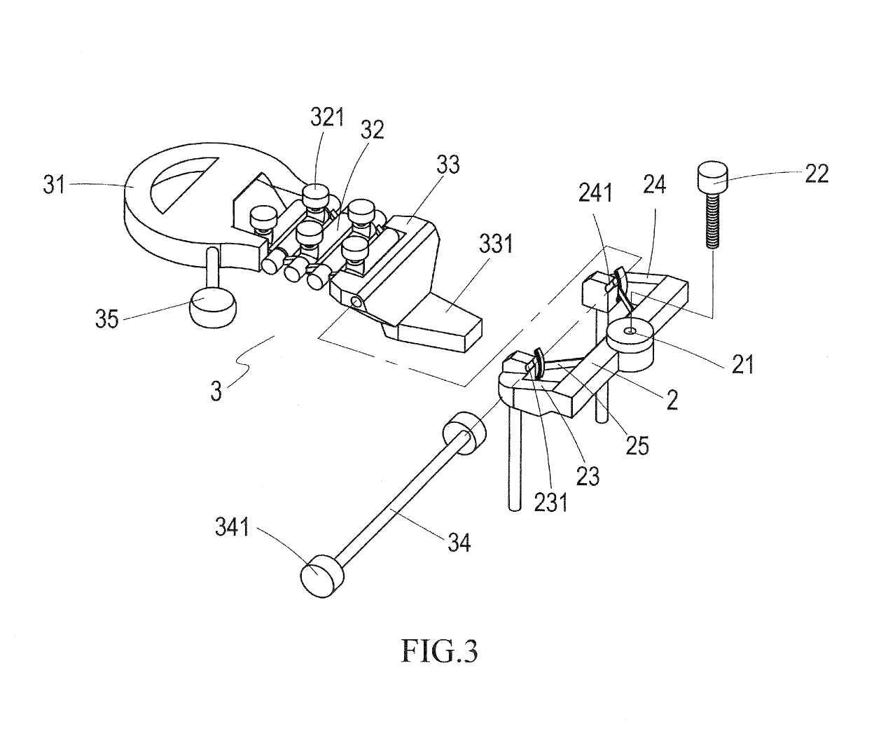

Referring to FIGS. 1-3, FIG. 1 is a perspective view of an articulator according to the present invention, FIG. 2 is an exploded view of the articulator according to the present invention, and FIG. 3 is an exploded view of a top and a cross bar of the articulator of the present invention. As shown, the present invention provides an articulator, generally designated at 100, which comprises a base 1, a cross bar 2, and a top 3. The base 1 comprises a mandibular cast receptacle 11. The mandibular cast receptacle 11 comprises a jointing portion 111. The mandibular cast receptacle 11 comprises a rotatable axle 12 that is set at a location corresponding to the jointing portion 111. The base 1 comprises two upward-extending height adjustable rods 13, 14. Each of the two height adjustable rods 13, 14 comprises an outer tube 131, 141 and an inner bar 132, 142. The inner bar 132 is telescopically received in the outer tube 131, and the inner bar 142 is telescopically received in the outer tube 141. The outer tubes 131, 141 are each provided with a height-adjustment locking element 133, 143.

The cross bar 2 is mounted to the two height adjustable rods 13, 14. The cross bar 2 forms an inner-threaded hole 21, and the inner-threaded hole 21 threadingly receives and engages an adjustment bolt 22. The cross bar 2 comprises two arms 23, 24 extending from opposite ends thereof in a frontward direction. Each of the arms 23, 24 forms a notch 231, 241. The cross bar 2 further comprises a spring plate 25 mounted thereto.

The top 3 is coupled to the two arms 23, 24 of the cross bar 2. The top 3 comprises a maxillary cast receptacle 31, a plurality of elevation adjusting elements 32, a lip 33, and a pivot shaft 34. The maxillary cast receptacle 31, the plurality of elevation adjusting elements 32, and the lip 33 are coupled together. The pivot shaft 34 extends through the lip 33, and the pivot shaft 34 is coupled to the notches 231, 241 of the two arms 23, 24 of the cross bar 2, whereby the top 3 is rotatable about the pivot shaft 34 with respect to the cross bar 2. The pivot shaft 34 has two ends to each of which a pivot shaft rotation knob 341 is mounted.

The elevation adjusting elements 32 are coupled to the lip 33, and each of the elevation adjusting elements 32 comprises a tightness adjusting element 321. The maxillary cast receptacle 31 is coupled to the elevation adjusting elements 32, and the maxillary cast receptacle 31 comprises a jointing portion 311. Further, the maxillary cast receptacle 31 comprises a rotatable axle 35 that is set at a location corresponding to the jointing portion 311. The lip 33 forms an extension 331, which extends under the adjustment bolt 22 to allow the adjustment bolt 22 to engage the extension 331.

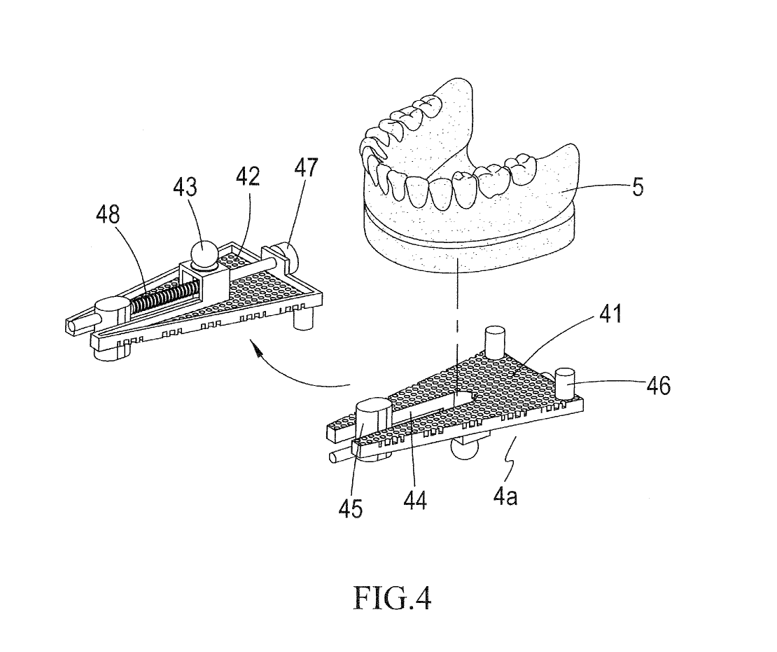

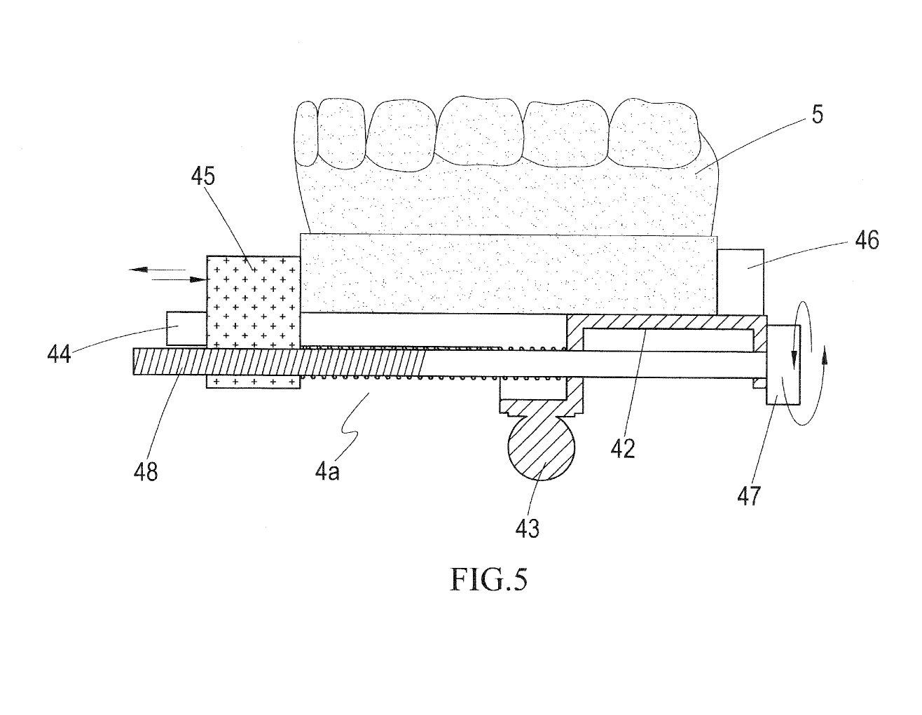

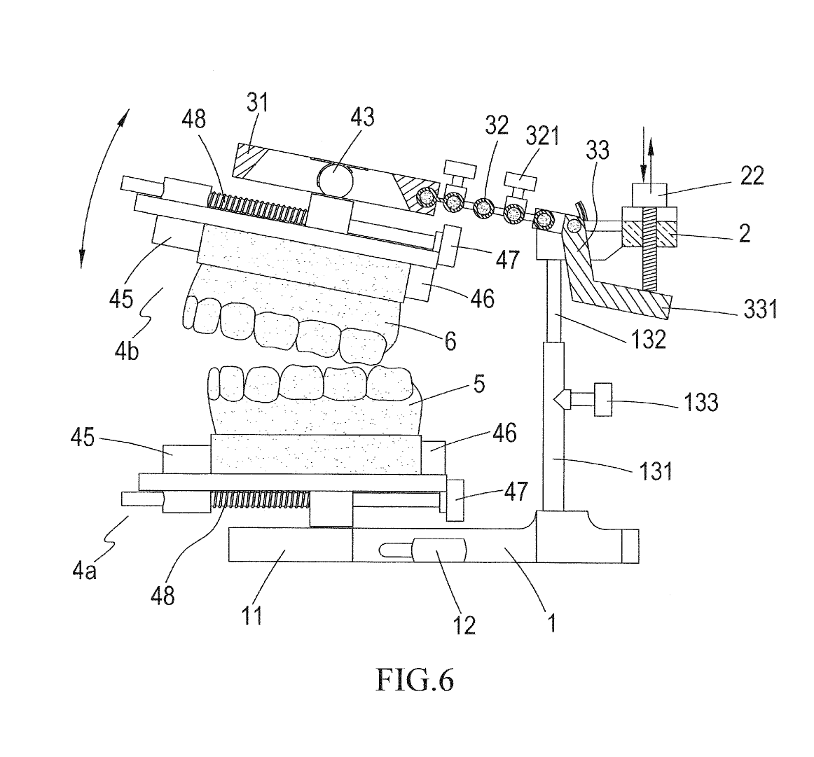

Referring to FIGS. 4-6, FIG. 4 is a schematic showing a cast and a cast holder seat according to a first embodiment, which are detached from each other, FIG. 5 is a schematic view showing the cast and the cast holder seat of the first embodiment, which are assembled together, FIG. 6 is a schematic view illustrating aligning of the casts. As shown in FIG. 6, the present invention further provides two cast holder seats 4a, 4b, and casts 5, 6 can be releasably coupled to the articulator according to the present invention by the cast holder seats 4a, 4b.

Referring to FIGS. 4 and 5, the cast holder seats 4a and the cast holder seats 4b are of substantially identical structure and only cast holder seat 4a is shown in the drawing for detailed description of the structure and the coupling of the cast 5 to the cast holder seat 4a.

The cast holder seat 4a has a top surface 41 and a bottom surface 42. The top surface 41 serves as a cast mounting surface. The bottom surface 42 comprises a receptacle jointing element 43. The cast holder seat 4a has a front end from which an inward-recessed slot 44 extends partially into the cast holder seat 4a. The inward-recessed slot 44 is provided with a first fixing member 45. The top surface 41 of the cast holder seat 4a has two lateral side portions each provided with a second fixing member 46. A rotation knob 47 is arranged between the two second fixing members 46. The rotation knob 47 is connected to a threaded bar 48. The threaded bar 48 extends through the receptacle jointing element 43 and is threadingly coupled to the first fixing member 45.

To couple the cast 5 to the cast holder seat 4a, a user rotates the rotation knob 47, and the rotation knob 47 in turn rotates the threaded bar 48. The threaded bar 48, subjected to such rotation, causes the first fixing member 45 to move in front-rear direction along the inward-recessed slot 44 to adjust the distance between the first fixing member 45 and the second fixing members 46 in order to allow for easy positioning of the cast 5 on the top surface 41 of the cast holder seat 4a. After the cast 5 is positioned on the top surface 41 of the cast holder seat 4a, the user operates the rotation knob 47 again to bring the first fixing member 45 into engagement with a front side of the cast 5, and at the same time, the second fixing members 46 are allowed to engage a rear side of the cast 5. This completes the coupling of the cast 5 to the cast holder seat 4a. Coupling the cast 6 to the cast holder seat 4b is identical to coupling the cast 5 to the cast holder seat 4a, so that repeated description will be omitted hereinafter.

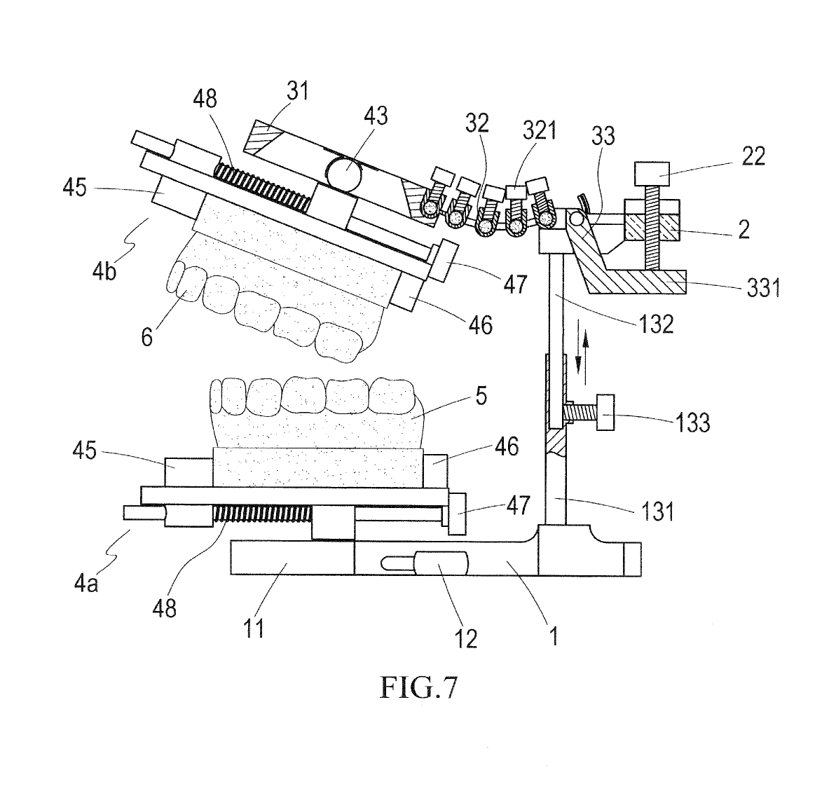

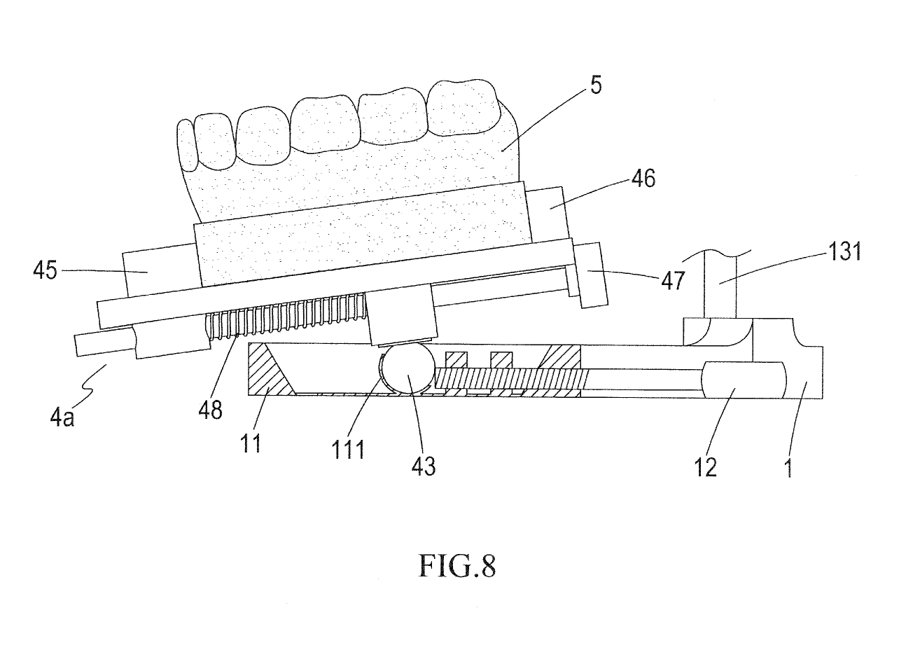

Referring to FIGS. 6-8, FIG. 6 is a schematic view illustrating aligning of the casts, FIG. 7 is another schematic view illustrating aligning of the casts, and FIG. 8 is a further schematic view illustrating aligning of the casts. To carry out simulation of mastication and occlusal adjustment of the casts, the casts 5, 6 are respectively coupled to the cast holder seats 4a, 4b, and then the cast holder seats 4a, 4b are respectively mounted to the mandibular cast receptacle 11 and the maxillary cast receptacle 31. Also referring to FIG. 1, to mount the cast holder seat 4a to the mandibular cast receptacle 11, the rotatable axle 12 of the mandibular cast receptacle 11 is first withdrawn to allow the receptacle jointing element 43 of the cast holder seats 4a to be positioned in the jointing portion 111 of the mandibular cast receptacle 11, and then the rotatable axle 12 is tightly rotated for fastening the cast holder seat 4a. To mount the cast holder seat 4b to the maxillary cast receptacle 31, the rotatable axle 35 of the mandibular cast receptacle 31 is first withdrawn to allow the receptacle jointing element 43 of the cast holder seats 4b to be positioned in the jointing portion 311 of the maxillary cast receptacle 31, and then the rotatable axle 35 is tightly rotated to fasten the cast holder seat 4b.

To perform simulation of mastication and occlusal adjustment of the casts 5, 6, a user first releases the height-adjustment locking elements 133, 143 of the height adjustable rods 13, 14, and the inner bars 132, 142 are moved to adjust the heights of the cross bar 2 and the top 3. After the adjustment, the height-adjustment locking elements 133, 143 are tightened against the inner bars 132, 142 to fix the cross bar 2 and the top 3 at the adjusted heights.

After the height adjustment, the user operates the adjustment bolt 22 to make ascending/descending adjustment of the maxillary cast receptacle 31 in order to adjust the angular position of the maxillary cast receptacle 31 for the subsequently performed simulation of mastication and occlusal adjustment of the casts 5, 6. In case there is still minor angular error in the mastication simulation of the casts 5, 6 after the adjustment of the angular position of the cast 6 as discussed above, the user may release the tightness adjusting element 321 of one or more elevation adjusting elements 32 in order to adjust the angle of the elevation adjusting element 32. After the adjustment, the tightness adjusting element 321 is tightened again. Thus, fine adjustment of the angular position of the maxillary cast receptacle 31 can be realized through adjustment of the angle of the elevation adjusting elements 32.

Further, the receptacle jointing element 43 of the cast holder seat 4a and the receptacle jointing element 43 of the cast holder seat 4b are both made spherical. The spherical structure of the receptacle jointing elements 43 allows the cast holder seats 4a, 4b to be arbitrarily rotated within the jointing portion 111 of the mandibular cast receptacle 11 and the jointing portion 311 of the maxillary cast receptacle 31 and through such rotations within the jointing portion 111 of the mandibular cast receptacle 11 and the jointing portion 311 of the maxillary cast receptacle 31, the casts 5, 6 can be arbitrarily oriented at any desired angular positions for proper simulation of mastication and occlusal adjustment of the casts 5, 6.

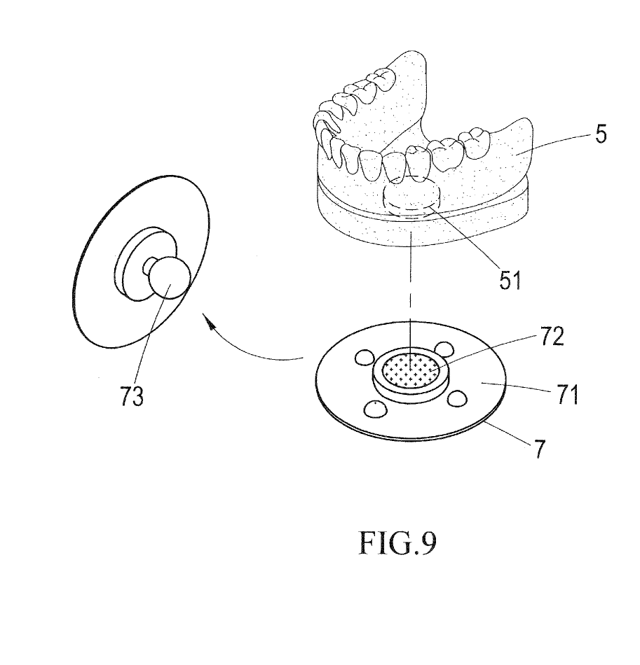

Referring to FIG. 9, which is a schematic view illustrating a cast and a cast retainer seat according to a second embodiment, which are detached from each other, the present invention may comprise two cast retainer seats 7, and casts 5, 6 can be coupled to the articulator of the present invention by the cast retainer seats 7. The structure and operation of the two cast retainer seats 7 are identical, so that only one cast retainer seat 7 is illustrated in the drawing for detailed description of the structure thereof and an explanation of the coupling between the cast 5 and the cast retainer seat 7.

The cast retainer seat 7 has a cast mounting surface 71. The cast mounting surface 71 comprises a suction element 72. The cast retainer seat 7 has a bottom forming a receptacle jointing element 73. The cast 5 has a bottom forming a counterpart suction element 51 corresponding to the suction element 72 of the cast retainer seat 7.

To couple the cast 5 to the cast retainer seat 7, the cast 5 is positioned on the cast mounting surface 71 of the cast retainer seat 7 to have the suction element 72 of the cast retainer seat 7 engaging and attractively attached to the counterpart suction element 51 on the bottom of the cast 5. This completes the coupling of the cast 5 to the cast retainer seat 7.

After the coupling of the cast 5 to the cast retainer seat 7, the cast 5 can be mounted by the cast retainer seat 7 to the jointing portion 111 of the mandibular cast receptacle 11 of the base 1.

Although in the embodiment illustrated, the cast mounting surface 71 of the cast retainer seat 7 is provided with a suction element 72 and the bottom of the cast 5 is provided with a counterpart suction element 51, yet it is feasible to provide a suction element on the bottom of the cast 5 and a counterpart suction element on the cast mounting surface 72, whereby through attractive engagement between the suction element and the counterpart suction element, the cast 5 is coupled to the cast retainer seat 7.

Further, the cast 6 can be coupled to another cast retainer seat 7 in the same way as the coupling of the cast 5 to the cast retainer seat 7. Repeated description will be omitted hereinafter.

Further, the structure and operation of the receptacle jointing element 73 on the bottom of the cast retainer seat 7 are similar to those of the receptacle jointing elements 43 of the cast holder seats 4a, 4b of the first embodiment, and the cast retainer seats 7 are mounted to the mandibular cast receptacle 11 and the maxillary cast receptacle 31 in the same way as the cast holder seats 4a, 4b being mounted to the mandibular cast receptacle and the maxillary cast receptacle 31. Description of mounting the cast retainer seats 7 to the mandibular cast receptacle 11 and the maxillary cast receptacle 31 will be omitted herein.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An articulator comprising:
a base comprising a mandibular cast receptacle comprising a first bowl-shaped joint and a first rotatable axle at a location corresponding to the first bowl-shaped joint;
two height adjustable rods extending upward from the base;
a cross bar mounted to the two height adjustable rods, the cross bar comprising two arms extending from opposite ends thereof;
a top rotatably coupled to the two arms of the cross bar, the top comprising a maxillary cast receptacle comprising a second bowl-shaped joint and a second rotatable axle at a location corresponding to the second bowl-shaped joint; and
a first cast holder seat mounted to the first bowl-shaped joint, wherein the first cast holder seat comprises a first ball-shaped joint at a surface thereof opposite to a first cast mounting surface thereof, wherein the first bowl-shaped joint receives the first ball-shaped joint with the first rotatable axle having a first end directly abutting against the first ball-shaped joint.

2. The articulator according to claim 1, wherein an inner-threaded hole in the cross bar threadedly receives and engages with an adjustment bolt, the cross bar comprising a spring plate mounted to two notches in the two arms of the cross bar.

3. The articulator according to claim 2, wherein the top comprises a lip, a pivot shaft, and multiple elevation adjusting elements coupled to the maxillary cast receptacle and the lip, the elevation adjusting elements each comprising a tightness adjusting element, the pivot shaft extending through the lip and being coupled to the notches of the two arms, whereby the top is rotatable about the pivot shaft, the lip comprising an extension extending under the adjustment bolt to allow the adjustment bolt to abut against the extension.

4. The articulator according to claim 1, wherein each of the two height adjustable rods comprises an outer tube and an inner bar, the inner bar being telescopically received in the outer tube, the outer tube being provided with a height-adjustment locking element abutting against the inner bar.

5. The articulator according to claim 1 further comprising a second cast holder seat mounted to the second bowl-shaped joint, the second cast holder seat comprising a a second ball-shaped joint at a surface thereof opposite to a second cast mounting surface thereof, wherein the second bowl-shaped joint receives the second ball-shaped joint with the second rotatable axle having a first end directly abutting against the second ball-shaped joint.

6. (canceled)

7. The articulator according to claim 1, wherein the first cast holder seat has a front end from which an inward-recessed slot extends partially into the first cast holder seat, the first cast holder seat comprising a first fixing member in the inward-recessed slot, the first cast holder seat having two lateral side portions each provided with a second fixing member, wherein a rotation knob is fixed to a threaded bar extending through and is threadedly coupled to the first fixing member.

8. The articulator according to claim 5, wherein the second cast holder seat has a front end from which an inward-recessed slot extends partially into the second cast holder seat, the second cast holder seat comprising a first fixing member in the inward-recessed slot, the second cast holder seat having two lateral side portions each provided with a second fixing member, wherein a rotation knob is fixed to a threaded bar extending through and is threadedly coupled to the first fixing member.

9. The articulator according to claim 1, wherein the first rotatable axle comprises a flat plate at a second end thereof far away from the first end thereof.

10. The articulator according to claim 5, wherein the second rotatable axle comprises a flat plate at a second end thereof far away from the first end thereof.
